(19) United States
(12) Patent Application Publication
(10) Pub. No.: US 2011/0064961 A1
(43) Pub. Date: Mar. 17, 2011

(54) Lacrosse handle trophy

(75) Inventor: Derek L. Craig, Austin, TX (US)

(73) Assignee: Mr. Derek L. Craig, Austin, TX (US)

(21) Appl. No.: 12/806,835

(22) Filed: Aug. 23, 2010

Related U.S. Application Data
(60) Provisional application No. 61/276,518, filed on Sep. 14, 2009.

(51) Int. Cl. G09F 19/00

(52) U.S. Cl. 428/542.4

(57) ABSTRACT

The Lacrosse Handle Trophy is a solid wood memento with the profile and length dimensions of standard men's and women's lacrosse stick handles. The trophy handle features a flattened area scooped out of the face of the profile that provides a larger surface for messaging or graphics. This flattened message area aligns with the face of the stick head to enable efficient and readable display.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, TABLE, OR COMPUTER PROGRAM LISTING COMPACT DISC APPENDIX

Not applicable.

### BACKGROUND OF THE INVENTION

A sports-related trophy or memento specific to the sport of lacrosse due to the basic form resembling an authentic lacrosse stick, or handle. Classifications involved include 473/513 Lacrosse Stick or Handle, as well as 428/542.4 Trophy or Memento.

The Lacrosse Handle Trophy modifies the standard handle shape to provide a larger surface area for featured graphics and aligns this area with the face of the head, allowing effective and readable display of the trophy.

### BRIEF SUMMARY OF THE INVENTION

A display trophy made of solid wood having the dimensions of standard men's and women's lacrosse handles and featuring a flattened area scooped out of the handle face that can be engraved or printed with an award message. The alignment of the flattened message area with the face of the stick head allows the message to be viewed when displayed on a vertical, angled or horizontal surface.

### BRIEF DESCRIPTION OF THE SEVERAL VIEWS OF THE DRAWING

FIG. 1: Shows the article with the flattened message area as it aligns with the face of the stick head when attached.

FIG. 2A: Shows the cross-section of a standard Men's trophy handle.

FIG. 2B: Shows the cross-section of a standard Women's trophy handle.

FIG. 3A: Shows the dimensions for a standard Men's trophy handle and the area of the flattened message area as viewed from the face.

FIG. 3B: Shows the dimensions for a standard Men's trophy handle and the profile of the flattened message area as viewed from the top.

FIG. 3A: Shows the dimensions for a standard Women's trophy handle and the area of the flattened message area as viewed from the face.

FIG. 3B: Shows the dimensions for a standard Women's trophy handle and the profile of the flattened message area as viewed from the top.

### DETAILED DESCRIPTION OF THE INVENTION

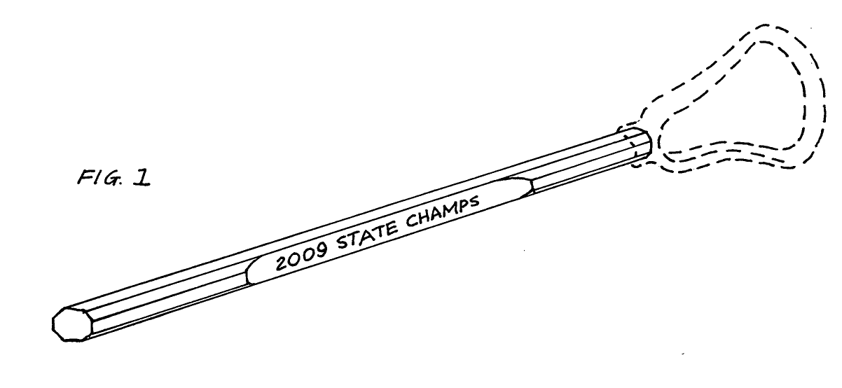

A display trophy made of solid wood, the traditional handle material for lacrosse sticks, having the profile and length dimensions of standard men's and women's lacrosse handles and featuring a flattened area scooped out of the handle face that can be engraved or printed with an award message. The alignment of the flattened message area with the face of the stick head (FIG. 1A) allows the message to be viewed when displayed on a vertical, angled or horizontal surface.

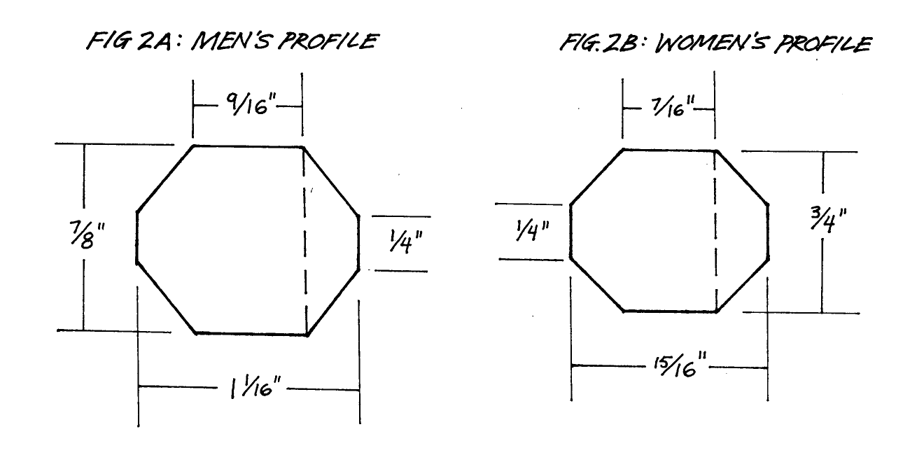

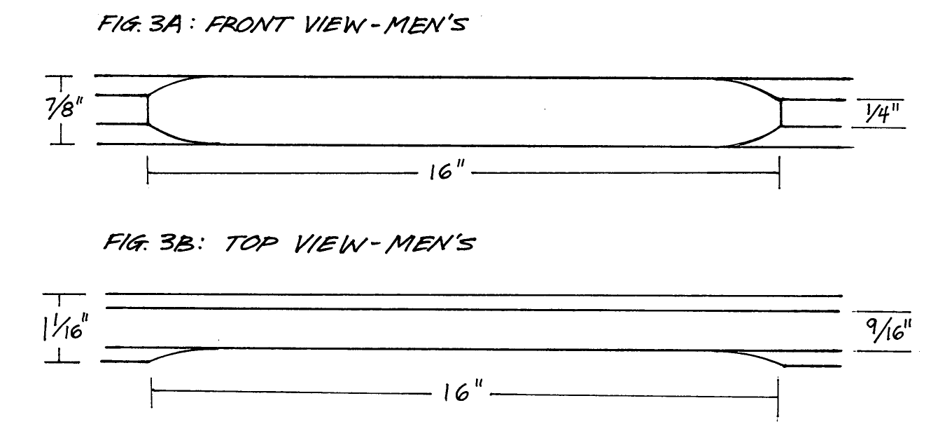

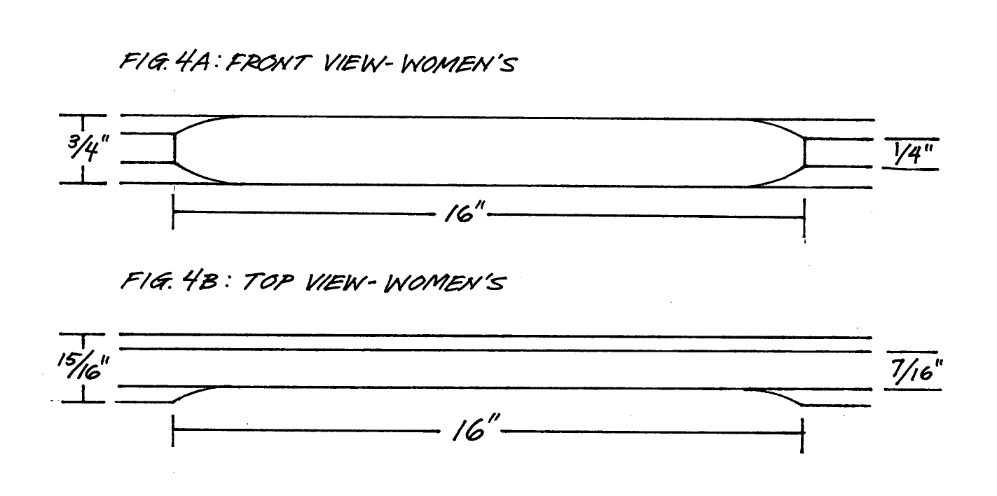

Trophy handles are constructed of solid wood using standard woodworking tools and techniques. Select lumber is cut (ripped) to men's profile dimension of 1 1/16″ ×⅞″, or women's profile of 15/16″ ×¾″. Edges of the wood strips are beveled to achieve a non-regular octagon shape (FIG. 2A and 2B). Women's profile handles have a standard length of 32″, while men's profile handles have three standard lengths of 30″, 40″ and 60″. The profile face is scooped out with a shaper to form the flattened message area. The message area is centered on the handle length with a standard length of 16″ (FIG. 3A, 3B, 4A and 4B), though actual length may vary depending on custom message.

The lacrosse trophy handle provides an authentic, personalized trophy option. They are distinct from regulation playing handles by having a modified profile, making them specifically for display. They are distinct from other trophies by resembling actual playing handles unique to the sport of lacrosse.

1) Article is distinct from standard trophies in that it resembles a standard lacrosse stick handle and can accept a standard lacrosse head for display.

2) The design is unique from standard lacrosse handles in its construction of solid wood, uncommon in current manufacturing, and in its shape, as the flattened message area limits the use to display.

3) The decoration or engraving applications to the handle are unique in that the flattened message area provides a larger graphic area than standard handles and aligns with the face of the stick head, creating proper alignment for display.
